(19) United States
(12) Patent Application Publication
(10) Pub. No.: US 2025/0236343 A1
(43) Pub. Date: Jul. 24, 2025

(54) VEHICLE FRONT END ALIGNMENT IMPROVEMENTS

(71) Applicant: Jaguar Land Rover Limited, Whitley, Coventry (GB)

(72) Inventors: Steve HARRIS, Gaydon, Warwickshire (GB); Ionica BALAN, Coventry, Warwickshire (GB); Jamie HOLTAM, Coventry, Warwickshire (GB); Christopher MOREL DU BOIL, Bont Goch, Aberystwyth (GB); Mark PARKES, Coventry, Warwickshire (GB); Sanjay PATEL, Leamington Spa, Warwickshire (GB); Joao RAMOS, Gaydon, Warwickshire (GB); Mark WILLIAMS, Coventry, Warwickshire (GB); Martin YOUNG, Coventry, Warwickshire (GB); Alan HUNT, Coventry, Warwickshire (GB)

(21) Appl. No.: 18/703,689

(22) PCT Filed: Oct. 20, 2022
(86) PCT No.: PCT/EP2022/079303

§ 371 Date: Apr. 22, 2024

(30) Foreign Application Priority Data
Oct. 20, 2021 (GB) 2114988.5

(51) Int. Cl. B62D 25/08; B60Q 1/00; B60R 19/18

(52) U.S. Cl. CPC B62D 25/085; B60Q 1/0023; B60R 19/18

(57) ABSTRACT

There is provided a system (900) and a vehicle (1). The system (900) comprises a front crossmember (810) for the vehicle (1), and a bumper rail (840) for positioning a front bumper assembly (8, 8A) of the vehicle (1). The front crossmember (810) comprises: a first body fixing point (812) securable to a vehicle body (100) of the vehicle (1) at a first lateral side of the vehicle body (100); a second body fixing point (812) securable to the vehicle body (100) at a second lateral side of the vehicle body (100); and bumper rail fixing points (824) configured to receive the bumper rail (840). The bumper rail (840) comprises: bumper assembly positioning points (858A, 858B) for setting a position of the front bumper assembly (8, 8A) in a direction; and a ranging sensor mount (854) to support a ranging sensor (860).

### TECHNICAL FIELD

The present disclosure relates to vehicle front end alignment improvements. In particular, but not exclusively it relates to a vehicle body, a front crossmember, and a headlamp assembly for improving vehicle front end alignment in a vehicle assembly line.

### BACKGROUND

Locating parts together to achieve consistent gaps and a flush fit and finish is frequently a challenge for vehicle manufacturers. The vehicle body-in-white (BIW) is typically one of the least accurate parts of any vehicle, and yet it acts as a support for all the exterior panels and other exterior parts of the vehicle. It can be difficult to ensure a flush fit and finish in all three dimensions. A flush fit and finish is also regarded as useful because ranging sensors are generally mounted to the exterior panels, and proper alignment of ranging sensors is desirable.

### SUMMARY OF THE INVENTION

It is an aim of the present invention to address one or more of the disadvantages associated with the prior art.

Aspects and embodiments of the invention provide a system, a vehicle body, vehicle, a front crossmember, and a headlamp assembly.

According to an aspect of the invention, there is provided a system comprising a front crossmember for a vehicle, and a bumper rail for positioning a front bumper assembly of the vehicle,
the front crossmember comprising:
   a first body fixing point securable to a vehicle body of the vehicle at a first lateral side of the vehicle body;
   a second body fixing point securable to the vehicle body at a second lateral side of the vehicle body; and bumper rail fixing points configured to receive the bumper rail,
the bumper rail comprising:
   bumper assembly positioning points for setting a position of the front bumper assembly in a direction; and
   a ranging sensor mount to support a ranging sensor.

An advantage of mounting the ranging sensor to the bumper rail rather than to the front bumper panel is that the position of the ranging sensor mount is less affected by vehicle body misalignments and panel misalignments. This is because front bumper panels are generally more misaligned due to a propagation of misalignments from the vehicle body to the outer surface of the vehicle. Accurate alignment of the ranging sensor mount is useful because ranging sensors should be placed at accurate locations on vehicles. A further advantage is protection of the ranging sensor from damage caused by low-speed vehicle collisions.

The ranging sensor may comprise a radio detection and ranging (RADAR) sensor. Additionally, or alternatively, the ranging sensor may comprise a light detection and ranging (LIDAR) sensor.

The bumper rail may extend between the first and second lateral sides of the vehicle body. The bumper rail may comprise a sloped portion to rotate an external impacted body about a lateral axis of rotation towards a hood panel of the vehicle.

The bumper rail may comprise a sloped portion. The ranging sensor mount may be supported at least in part by the sloped portion of the bumper rail.

The bumper rail may comprise an upper member securable to the front crossmember, and a lower member. The lower member may be at a lower elevation than the upper member and is at a fore location relative to the upper member. The sloped portion may interconnect the lower and upper members.

A longitudinal position of the ranging sensor mount may be recessed in a vehicle-aft direction relative to the lower member.

The bumper assembly positioning points may be arranged to hold the front bumper assembly at a longitudinal position fore of the lower member of the bumper rail and the ranging sensor mount.

A lower portion of the ranging sensor mount may be supported by the lower member.

The sloped portion may comprise a plurality of crumple members. The ranging sensor mount may be supported at least in part by a first subset of the crumple members.

An advantage is that displacement of the ranging sensor mount is minimised in low-speed impacts. This is because the numerous quantity of crumple members ensure that deformation is spread over a wide lateral area. Additionally, the displacement of crumple members not belonging to the first subset may not displace the ranging sensor mount at all.

A second subset of the crumple members comprises a plurality of substantially parallel crumple members. The first subset of crumple members may extend at a different angle than the second subset to support an upper portion of the ranging sensor mount to hold the ranging sensor mount in an upright orientation.

The bumper rail may comprise a material having a lower rigidity than a material of the front crossmember.

The bumper rail may comprise a datum point to visually indicate a reference datum of the bumper rail.

The front crossmember may comprise a first headlamp assembly aligner configured to guide a first headlamp assembly at the first lateral side of the vehicle body towards an aligned position. The front crossmember may comprise a second headlamp assembly aligner, at a set lateral distance from the first headlamp assembly aligner, configured to guide a second headlamp assembly at the second lateral side of the vehicle body towards an aligned position. An advantage is that the vehicle front end alignment is improved.

The direction in which the bumper assembly positioning points are configured to set a position of the front bumper assembly may be a lateral direction.

According to another aspect of the invention, there is provided a system comprising a front crossmember for a vehicle, and a bumper rail for positioning a front bumper assembly of the vehicle,
the front crossmember comprising:
   a first body fixing point securable to a vehicle body of the vehicle at a first lateral side of the vehicle body;
   a second body fixing point securable to the vehicle body at a second lateral side of the vehicle body; and
   bumper rail fixing points configured to receive the bumper rail,
the bumper rail comprising
   bumper assembly positioning points for setting a position of the front bumper assembly in a direction, and
   a sensor mount to support a sensor.

According to a further aspect of the invention, there is provided a vehicle comprising the system, and the vehicle body.

The vehicle body may comprise front crossmember fixing points configured to receive fixings from a first direction when the front crossmember is secured to at least the front crossmember fixing point. The vehicle body may comprise further fixing points configured to receive fixings from a direction substantially parallel to the first direction when one or more vehicle body panels and/or headlamp assemblies configured to interface with the front bumper assembly are secured to the further fixing points.

An advantage is that the ranging sensor mount is protected from displacement because other parts of the vehicle are prevented from pushing the front bumper assembly out of alignment, which could cause displacement of the bumper rail.

A portion of a laterally flexible connector may be mounted to each front crossmember fixing point. Each laterally flexible connector may be configured to connect a respective headlamp assembly to the vehicle body.

According to a further aspect of the invention there is provided a vehicle body comprising
a hood fixing point configured to receive one or more fixings from a first direction when a hood panel is secured to the hood fixing point;
a fender fixing point configured to receive one or more fixings from a direction substantially parallel to the first direction when a fender panel is secured to at least the fender fixing point; and
a first headlamp assembly fixing point configured to receive a fixing from a direction substantially parallel to the first direction when a headlamp assembly is secured to the first headlamp assembly fixing point.

An advantage is that the assembler has greater control over the alignment of the exterior parts, than if the fixing points face different directions than each other. Each fixing point can be set accurately using process equipment in adjacent assembly stations. Once set, the features on these parts create the primary geometric relationships between the hood panel, the fender panels and the headlamp assemblies.

The vehicle body may comprise a second headlamp assembly fixing point configured to receive a fixing from a direction substantially parallel to the first direction when the headlamp assembly is secured to at least the first and second headlamp fixing points. The vehicle body may comprise a third headlamp assembly fixing point configured to receive a fixing from a direction substantially parallel to the first direction when the headlamp assembly is secured to at least the first, second and third headlamp fixing points.

An advantage is that the assembler has greater control over the alignment of the headlamp assembly relative to other panels of the vehicle, than if the headlamp assembly fixing points face different directions than each other.

The fender fixing point may be configured as a further headlamp assembly fixing point to enable the headlamp assembly to be secured to at least part of the fender fixing point.

An advantage of this shared fixing point is enabling improved alignment of the headlamp-to-fender interface.

The vehicle body may comprise a front crossmember fixing point configured to receive one or more fixings from a direction substantially parallel to the first direction when a front crossmember is secured to at least the front crossmember fixing point.

An advantage is that the headlamp assemblies can be precisely aligned with each other, via the front crossmember, such that a grille opening has an accurate width.

The hood fixing point, the fender fixing point and the first headlamp assembly fixing point may each comprise a bearing surface substantially parallel to a first plane, wherein the first plane is perpendicular to the first direction.

According to another aspect of the invention there is provided a front crossmember for a vehicle, the front crossmember configured to interconnect a first lateral side of a vehicle body and a second lateral side of the vehicle body, the front crossmember comprising:
a first body fixing point securable to the vehicle body at the first lateral side of the vehicle body;
a second body fixing point securable to the vehicle body at the second lateral side of the vehicle body;
a first headlamp assembly aligner configured to guide a first headlamp assembly at the first lateral side of the vehicle body towards an aligned position; and
a second headlamp assembly aligner, at a set lateral distance from the first headlamp assembly aligner, configured to guide a second headlamp assembly at the second lateral side of the vehicle body towards an aligned position.

An advantage is that the headlamp assemblies can be precisely aligned with each other, via the front crossmember, such that a grille opening has an accurate width to ensure accurate headlamp-to-grille interfaces.

The first and second body fixing points and the first and second headlamp assembly aligners may be located at a common substantially flat surface of the front crossmember, to enable the front crossmember to rest on corresponding front crossmember fixing points of the vehicle body until the first and second body fixing points are secured to the front crossmember fixing points.

An advantage is assisting the alignment process, because the front crossmember does not need to be secured or externally supported during front end alignment.

The front crossmember may comprise bumper rail fixing points configured to receive a bumper rail for positioning a front bumper panel of the vehicle. The bumper rail may comprise front bumper positioning points for setting a position of the front bumper panel in a direction, such as a vertical direction.

An advantage is that the front crossmember can align the headlamp-to-bumper interfaces as well as the headlamp-to-grille interfaces.

The bumper rail may comprise a sloped portion to rotate an external impacted body about a lateral axis of rotation towards a hood panel of the vehicle, and/or wherein the bumper rail comprises a material having a lower rigidity than a material (e.g., profile of structural metal) of the front crossmember.

An advantage is that the front crossmember is afunctional component adapted to incorporate the headlamp assembly aligners, without adding to the part count/weight of the vehicle by adding a single-purpose headlamp assembly aligner.

The bumper rail may comprise a datum point to visually indicate a reference datum of the bumper rail. An advantage is helping the aligner to centre the bumper panel, for accurate headlamp-to-bumper interfaces.

According to a further aspect of the invention there is provided a headlamp assembly for a vehicle, the headlamp assembly comprising: a grille locator configured to receive a rear-facing grille protrusion of a grille, wherein the grille locator is configured to guide the grille to align a headlamp-to-grille interface as the rear-facing grille protrusion is engaged with the grille locator The grille may be for extending laterally between the headlamp assembly and another headlamp assembly.

An advantage of providing the grille locator on the headlamp assembly rather than on another part of the vehicle is that the headlamp-to-grille interface is optimised and not affected by misalignment of the vehicle body.

The grille locator may comprise a guide platform configured to support the rear-facing grille protrusion of the grille at a height that sets a vertical alignment of the headlamp-to-grille interface. This is an advantage in examples in which the headlamp-to-grille interface needs to be vertically aligned due to its shape, and not just laterally aligned.

The headlamp assembly may comprise a portion of a laterally flexible connector, wherein the laterally flexible connector is configured to connect the headlamp assembly to a fixing point (e.g., front crossmember fixing point) on the vehicle body.

An advantage is that a lateral reaction force of the laterally flexible connector through the left and right headlamp assemblies helps to self-centralise the front grille (and by extension the front bumper panel) between the headlamp assemblies.

The headlamp assembly may comprise a bumper locator configured to engage with a rear-facing bumper portion of a front bumper panel, wherein the bumper locator may be configured to align a headlamp-to-bumper interface as the rear-facing bumper portion is engaged with the bumper locator. The bumper locator may comprise bumper securing means (652, 654) to secure the front bumper panel at a position in which the headlamp-to-bumper interface is aligned.

An advantage of the headlamp assembly comprising the bumper locator is that the headlamp assembly can not only optimise the headlamp-to-grille interface, but can also optimise a headlamp-to-bumper interface.

The headlamp assembly may comprise a fixing point configured to enable the headlamp assembly to be secured to at least part of a fixing point shared with a fender, to align a headlamp-to-fender interface.

An advantage is that the headlamp assembly can also optimise the headlamp-to-fender interface.

The headlamp assembly may comprise a second fixing point configured to enable the headlamp assembly to be secured to a carrier structure associated with a vehicle body of the vehicle. As described in a previous aspect, the first fixing point may be configured to receive a fixing from a first direction, and the second fixing point may be configured to receive a fixing from a direction substantially parallel to the first direction. This has the associated advantage of greater control over the alignment of the headlamp assembly.

The headlamp assembly may comprise a headlamp-to-crossmember aligner configured to enable the headlamp assembly to be aligned with a headlamp assembly aligner of a front crossmember of the vehicle, to enable relative alignment between the headlamp assembly and the front crossmember.

An advantage is that the headlamp assemblies can be precisely aligned with each other, via the front crossmember, such that a grille opening has an accurate width to ensure accurate headlamp-to-grille interfaces.

According to a further aspect of the invention there is provided a vehicle body comprising
a panel fixing point configured to receive one or more fixings from a first direction when a vehicle body panel configured to interface with a headlamp assembly is secured to the panel fixing point; and
a first headlamp assembly fixing point configured to receive a fixing from a direction substantially parallel to the first direction when the headlamp assembly is secured to the first headlamp assembly fixing point.

According to a further aspect of the invention there is provided a vehicle comprising the vehicle body and/or comprising the front crossmember and/or comprising the headlamp assembly.

Within the scope of this application it is expressly intended that the various aspects, embodiments, examples and alternatives set out in the preceding paragraphs, in the claims and/or in the following description and drawings, and in particular the individual features thereof, may be taken independently or in any combination that falls within the scope of the appended claims. That is, all embodiments and/or features of any embodiment can be combined in any way and/or combination that falls within the scope of the appended claims, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 illustrates an example of a vehicle;

FIG. 2 illustrates an example of a vehicle front end;

FIG. 3 illustrates an example of vehicle body fixing points,

FIG. 4 illustrates an example of a front crossmember;

FIG. 5 illustrates an example of a front crossmember, a bracket, and a bumper rail,

FIG. 6 illustrates an example of a headlamp assembly housing;

FIG. 7 illustrates an example of a connection between a headlamp assembly housing and a front crossmember;

FIG. 8 illustrates an example of a headlamp assembly lens body comprising a grille locator and illustrates an example of a grille comprising a grille locator engaging portion;

FIG. 9 illustrates an example of a headlamp assembly lens body comprising a grille locator;

FIG. 10 illustrates an example of a bumper locator of a headlamp assembly;

FIG. 11 illustrates an example of a laterally flexible connection between a headlamp assembly and a front crossmember fixing point;

FIG. 12 illustrates an example of alignment of a rear-facing grille protrusion and a grille locator; and

FIG. 13 illustrates an example of a bumper support bracket having a ranging sensor mount.

### DETAILED DESCRIPTION

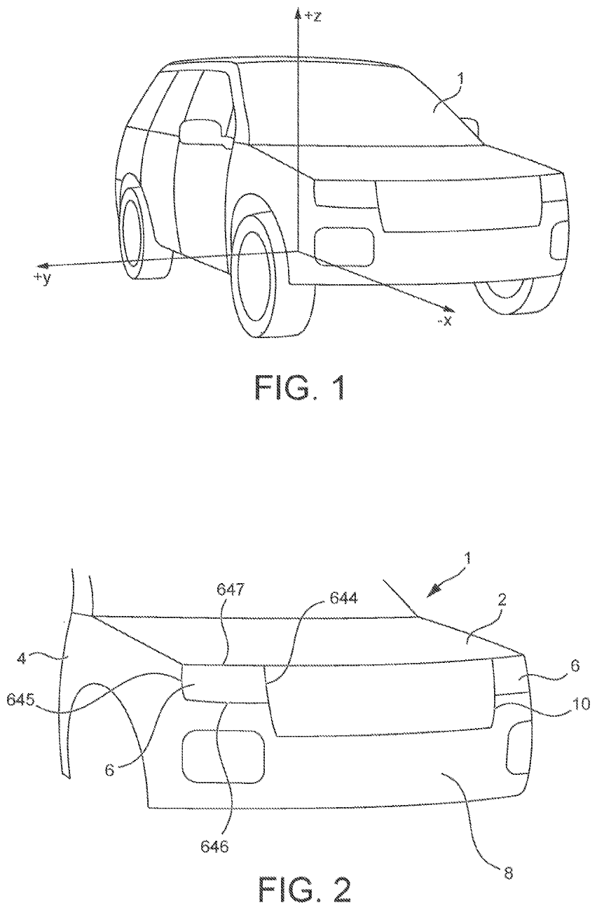

FIG. 1 illustrates an example of a vehicle 1 in which embodiments of the invention can be implemented. In some, but not necessarily all examples, the vehicle 1 is a passenger vehicle, also referred to as a passenger car or as an automobile. In other examples, embodiments of the invention can be implemented for other applications, such as commercial vehicles.

FIG. 1 is a front perspective view and illustrates a longitudinal x-axis between the front and rear of the vehicle 1 representing a centreline, an orthogonal lateral y-axis between left and right lateral sides of the vehicle 1, and a vertical z-axis. A forward/fore direction typically faced by a driver's seat is in the negative x-direction; rearward/aft is +x. A rightward direction as seen from the driver's seat is in the positive y-direction; leftward is −y. These are a first lateral direction and a second lateral direction.

FIG. 2 illustrates a vehicle front end of the vehicle 1. The vehicle 1 comprises a hood panel 2, fender panels 4, headlamp assemblies 6, a front grille 10, and a front bumper panel 8.

A hood panel 2 is also referred to as a bonnet. In some examples, the hood panel 2 can be opened via hood hinges to enable access to an internal front compartment of the vehicle 1. The hood panel 2 may be shaped to define: fender-to-hood interfaces (lateral edges); headlamp-to-hood interfaces (fore edge, outboard); a grille-to-hood interface (fore edge, inboard); and the hood panel 2 may comprise an aft edge proximal to a front windscreen of the vehicle 1.

A fender panel 4 is also referred to as a quarter panel. The fender panels 4 are to each lateral side of the vehicle 1. Each fender panel 4 can be shaped to define: a fender-to-wheel arch interface (lower edge); a fender-to-hood interface (upper edge); a fender-to-door interface (aft edge); and a fender-to-bumper interface (fore edge).

The headlamp assemblies 6 are located to each lateral side of the vehicle 1. A headlamp assembly 6 may be operable in use to provide a low beam and/or a high beam function. The headlamp assembly 6 may further be operable in use to provide a left or right indicator function, and/or a daytime running light function. The edges of the headlamp assembly 6 can define a headlamp-to-fender interface 645 (aft lower edge), a headlamp-to-bumper interface 646 (fore lower edge), a headlamp-to-grille interface 644 (inner lateral edge), and a headlamp-to-hood interface 647 (upper edge).

The front grille 10 may be a panel disposed between the headlamp assemblies 6. The front grille 10 may be approximately at the same height as the headlamp assemblies 6. For vehicles with multiple front grilles, a front grille 10 at this position is generally referred to as an upper front grille or headlamp grille. The front grille 10 may comprise air inlets. However, some vehicles may not require a functional front grille so the front grille 10 could be a ‘blank’ without air inlets. The front grille 10 may be shaped to define: a grille-to-hood interface (upper edge); the headlamp-to-grille interfaces 644 (lateral edges), and a grille-to-bumper interface (lower edge).

The front bumper panel 8 may be located below the front grille 10 and the headlamp assemblies 6. The front bumper panel 8 may be of the type that comprises a single panel extending between the left and right lateral sides of the vehicle 1, the single panel comprising a plastic such as an injection-moulded thermoplastic. The front bumper panel 8 may be shaped to define the grille-to-bumper interface (upper edge, central), the headlamp-to-bumper interfaces 646 (upper edge, lateral), and the fender-to-bumper-interfaces (lateral edges).

Front end alignment herein refers to the assembly line stage of fitting the headlamp assemblies 6, the front grille 10, the front bumper panel 8, the hood panel 2, and the front fender panels 4 in an aligned manner, to control the aforementioned interfaces. The fitment should keep the gaps between the edges of the above parts to within a controlled tolerance. In other words, the gaps should be small and consistent. As mentioned in the background of this disclosure, this is a difficult process because the BIW 100 comprising the mounting points for supporting the above parts typically comprises areas of geometric inaccuracy. Misalignment between the headlamp assemblies 6 and their neighbouring panels can be more noticeable than misalignment in other areas of the vehicle 1. Said misalignment is addressed in examples of this disclosure. Misalignment of the headlamp-to-grille interface 644 can be more noticeable than misalignment around other edges of the headlamp assembly 6. This is especially the case where the headlamp-to-grille interface 644 is a complex three-dimensional shape, such as the notched shape shown in FIG. 2. Therefore, some examples of the present disclosure provide solutions for minimising said misalignment.

Other misalignments can also be undesirable, such as misalignment of the headlamp-to-bumper interface 646 or misalignment of the headlamp-to-fender interface 645. Focusing too much attention on the headlamp-to-grille interface 644 can simply ‘push’ the misalignment to these other locations. Some misalignments may be less noticeable, such as misalignment of the headlamp-to-hood interface 647. In examples, misalignments can be ‘pushed’ to these less noticeable locations.

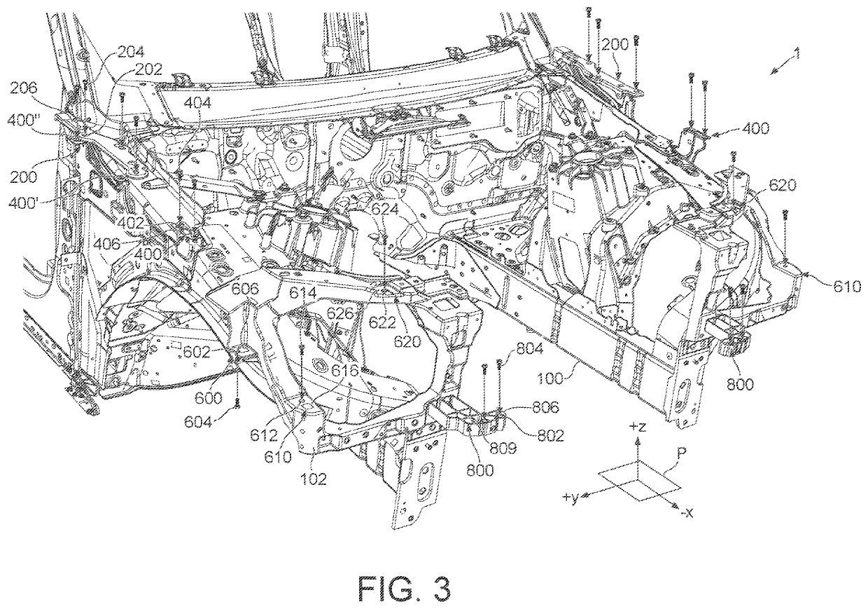

FIG. 3 illustrates a front end of a vehicle body 100 of the vehicle 1. The vehicle body 100 may comprise a BIW. The vehicle body 100 comprises fixing points (fixing portions) for securing at least some of the exterior parts of FIG. 2 to the vehicle body 100.

As illustrated in FIG. 3, different fixing points for different exterior parts are parallel to a common, first plane P. Therefore, fixings such as bolts are all inserted from a direction substantially parallel to a common first direction, perpendicular to the first plane P. The term ‘substantially parallel’ means that the fixing directions are parallel enough that relative misalignment of the fixing points in one plane does not force substantial component misalignment in other planes. The term ‘substantially parallel’ includes angles that are wholly parallel and angles within 10 degrees of being completely parallel, or at most within 15 degrees of being completely parallel. An advantage is that the assembler has greater control over the alignment of the exterior parts, than if the fixing points face different directions than each other. For example, the fixing points of the illustrated vehicle body 100 comprise hood fixing points 200, fender fixing points 400, front crossmember fixing points 800, and headlamp assembly fixing points 600, 610, 620 (and 400, 800 which may be shared). A hood fixing point 200 is provided to each lateral side of the vehicle body 100. The hood fixing point 200 may comprise a hood hinge fixing point. The hood fixing point 200 may comprise a substrate to which a hood hinge assembly (not shown) can be mounted.

The hood fixing point 200 of FIG. 3 comprises one or more fixing openings 202 each configured to receive a fixing 204, such as a bolt. The fixing openings 202 may be for the connection of a portion of a hood hinge assembly. The fixing openings 202 of the hood fixing point 200 are each configured to receive a fixing from a direction substantially parallel to the first direction. Each fixing opening 202 is surrounded by a bearing surface 206 for reacting against a force of the fixing. The bearing surface 206 around each fixing opening 202 is substantially flat and is substantially parallel to the first plane P. A fender fixing point 400 is provided to each lateral side of the vehicle body 100. The fender fixing point 400 is for securing a fender panel 4 to the vehicle body 100. The fender fixing point 400 may comprise one or more fixing openings 402 each configured to receive a fixing, such as a bolt. The fixing openings 402 of the fender fixing point 400 may be for the connection of an upper part of the fender panel 4. The fixing openings 402 of the fender fixing point 400 are each configured to receive a fixing from a direction substantially parallel to the first direction. Each fixing opening 402 is surrounded by a bearing surface 406 for reacting against the force of the fixing. The bearing surface 406 around each fixing opening 402 is substantially flat and is substantially parallel to the first plane P. The illustrated fender fixing point 400 is located fore of the hood fixing point 200.

One or more further fender fixing points 400′, 400″, aft of the fender fixing point 400, can be provided to each lateral side of the vehicle body 100 and proximal to the hood fixing points 200.

One or more headlamp assembly fixing points 600, 610, 620, 400, 800 are provided for each headlamp assembly 6. The headlamp assembly fixing points 600, 610, 620, 400, 800 are for securing a headlamp assembly 6 to the vehicle body 100.

FIG. 3 illustrates a plurality of headlamp assembly fixing points 600, 610, 620, 400, 800 for each headlamp assembly 6. FIG. 3 illustrates five headlamp assembly fixing points 600, 610, 620, 400, 800 for each headlamp assembly 6, some of which (400, 800) may be shared with other parts. In other examples, fewer than five or more than five headlamp assembly fixing points can be provided.

Each of the headlamp assembly fixing points 600, 610, 620, 400, 800 for a headlamp assembly 6 may comprise a fixing opening 602, 612, 622, 402, 802 configured to receive a fixing 604, 614, 624, 404, 804 such as a bolt. The fixing openings 602, 612, 622, 402, 802 of the headlamp assembly fixing points 600, 610, 620, 400, 800 for the headlamp assembly 6 are each configured to receive the fixing 604, 614, 624, 404, 804 from a direction substantially parallel to the first direction.

Each fixing opening 602, 612, 622, 402, 802 is surrounded by a bearing surface 606, 616, 626, 406, 806 for reacting against the force of the fixing. The bearing surface 606, 616, 626, 406, 806 around each fixing opening 602, 612, 622, 402, 802 is substantially flat and is substantially parallel to the first plane P.

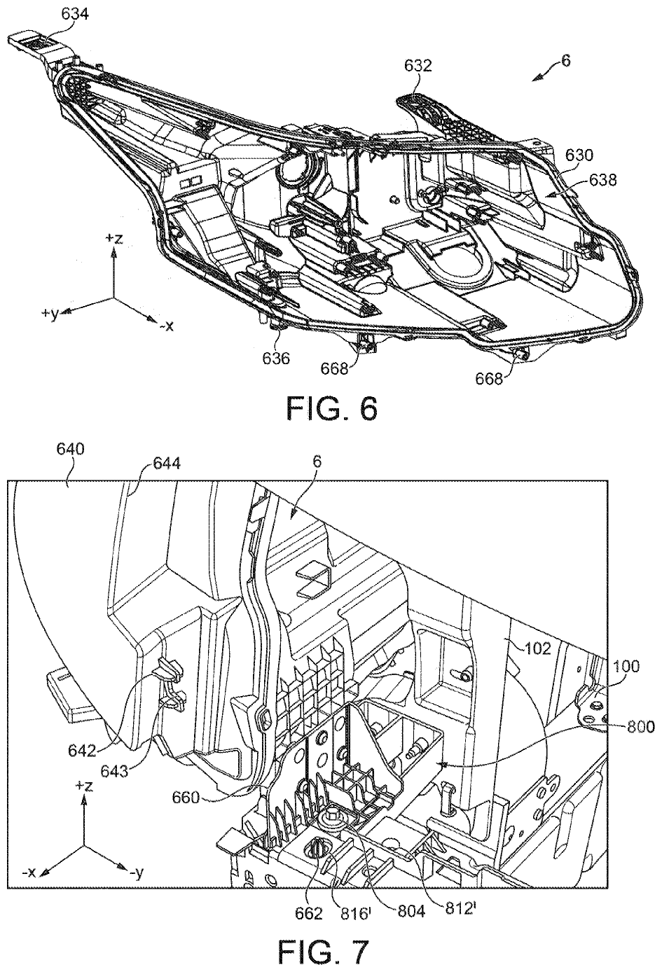

Referring to FIGS. 3 and 6-7, the headlamp assembly 6 can comprise fixing points 632, 634, 636 alignable with the corresponding headlamp assembly fixing points 600, 610, 620, 400 of the vehicle body 100 FIG. 6 illustrates a headlamp assembly housing 630, such as a moulded polymeric part, which comprises the alignable fixing points 632, 634, 636.

One or more of the alignable fixing points 632, 634, 636 of the headlamp assembly housing 630 can comprise brackets having slotted or round openings through which a fixing can extend into a fixing opening (e.g., socket) 602, 612, 622, 402 of the corresponding headlamp assembly fixing point 600, 610, 620, 400 of the vehicle body 100. At least one of the alignable fixing points 636 of the headlamp assembly housing 630 can comprise a socket to receive a fixing inserted through a headlamp assembly fixing point 600 of the vehicle body 100.

In some examples, one of the headlamp assembly fixing points for a headlamp assembly 6 is also the fender fixing point 400 as described above. An advantage of this shared fixing point 400 is enabling improved alignment of the headlamp-to-fender interface 645.

In some examples, at least some of the headlamp assembly fixing points 600, 610, 620 are comprised on a carrier structure 102 associated with the vehicle body 100. The carrier structure 102 may be a structural part comprising a structural metal/material (e.g., aluminium), and secured to the BIW 100 for example by rivets and/or welds. The use of a single distinct carrier structure 102 to provide multiple headlamp assembly fixing points 600, 610, 620 is advantageous because the carrier structure 102 can be manufactured more accurately than the larger BIW 100.

The use of multiple headlamp assembly fixing points 600, 610, 620, 400 means that the headlamp assembly fixing points 600, 610, 620, 400 can be arranged each at a different elevation (z), lateral position (y) and longitudinal position (x) than each other, to define a three-dimensional shape. This shape, combined with the use of a common fixing direction and slotted fixing points, enables freedom to align the headlamp assembly 6 in three dimensions. Slotted fixing points may be included on the headlamp assembly 6 and/or on the vehicle body 100.

As shown in FIG. 3, a front crossmember fixing point 800 can be provided to each lateral side of the vehicle body 100. The front crossmember fixing point 800 is configured to support a later-explained front crossmember 810 of the vehicle 1 and can also be a headlamp assembly fixing point.

The front crossmember fixing point 800 may be supported by the carrier structure 102 of the vehicle body 100. The front crossmember fixing point 800 may be a structural part fixed to the carrier structure 102 or could be an integral part of the carrier structure 102. The front crossmember fixing point 800 may be located towards a front of the carrier structure 102.

A headlamp inner portion 660 (FIG. 7) of the headlamp assembly 6, such as a headlamp inner bracket, may comprise an opening alignable with a fixing opening 802 of the front crossmember fixing point 800, and a fixing 804 such as a bolt is inserted therethrough from a direction substantially parallel to the first direction. As with the other fixing points, the bearing surface 806 around the fixing opening 802 may be substantially flat and substantially parallel to the first plane P.

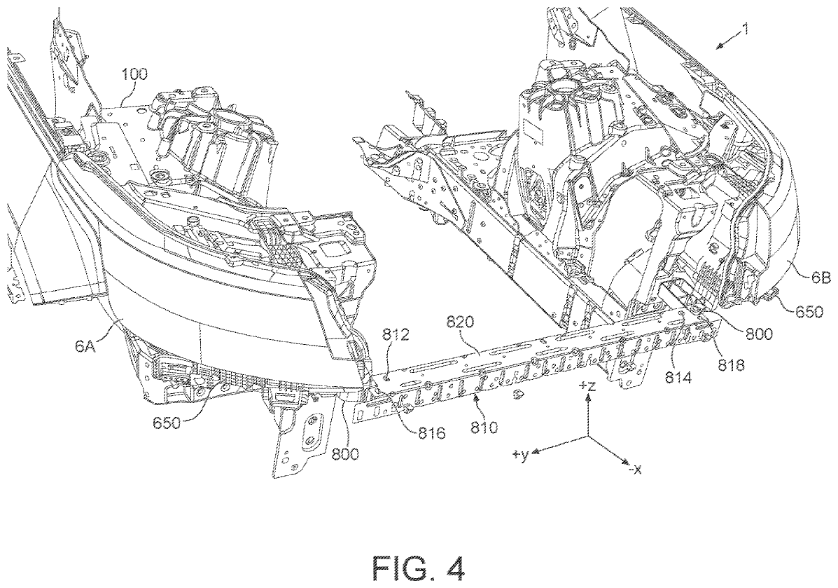

The front crossmember 810, shown in FIGS. 4, 5 and 7, is configured to interconnect a first lateral side (left) of the vehicle body 100 with a second lateral side (right) of the vehicle body 100. The front crossmember 810 may be a beam extending in the y-axis direction across the front of the vehicle 1, behind the bumper panel 8. The front crossmember 810 may extend in a substantially horizontal direction. The front crossmember 810 may have various functions, described below.

The front crossmember 810 can comprise a structural part comprising a structural metal/material (e.g., aluminium). The front crossmember 810 may be configured as a pedestrian beam, having a rigidity adapted to deform in the event of a vehicle impact with a pedestrian.

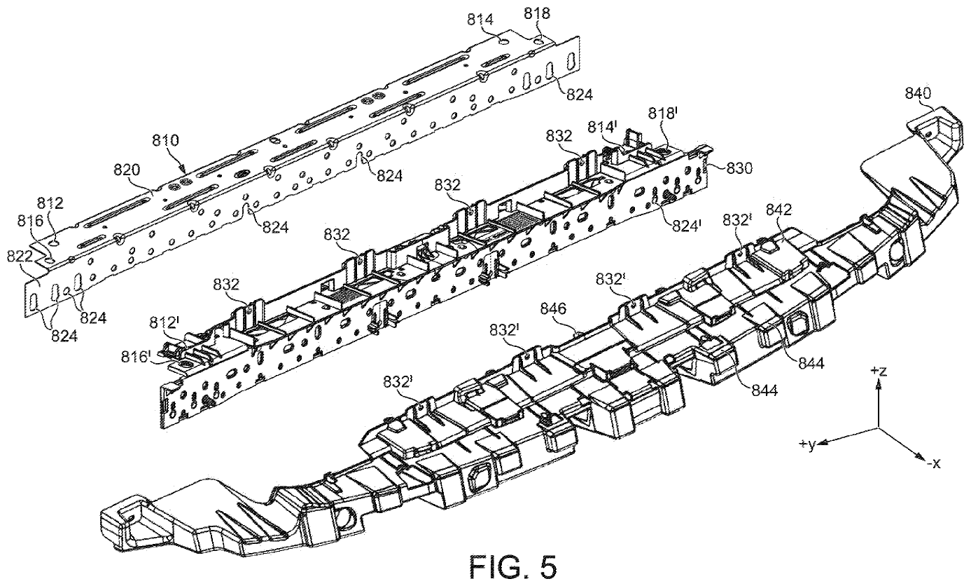

The front crossmember 810 further influences front end alignment. The front crossmember 810 functions as a centralising crossmember to set the lateral relationship between the headlamp assemblies 6 across the vehicle 1, creating a controlled aperture to fit the front grille 10 subsequently. The front crossmember 810 may also support a bumper rail 840A (FIG. 5) that sets a position of the front bumper panel 8 in a direction, such as a vertical direction. Therefore, the front crossmember 810 influences the headlamp-to-grille interface alignment and the headlamp-to-bumper interface alignment.

The front crossmember 810 may comprise a profile of structural metal. The cross-section shape of the front crossmember 810 may comprise a horizontal leg 820 and a vertical leg 822, such as an L-section profile. Each front crossmember fixing point 800 of the vehicle body 100 may be shaped to support an opposite end region of the front crossmember 810. The front crossmember 810 may span between the front crossmember fixing points 800. The front crossmember 810 comprises a first body fixing point 812 towards one of its ends and a second body fixing point 814 towards its other end. Each body fixing point 812, 814 is securable to a fixing opening 802 of a respective front crossmember fixing point 800. Each body fixing point 812, 814 can comprise a fixing opening alignable with the fixing opening 802 of the front crossmember fixing point 800, so that a fixing 804 can be inserted therethrough in a direction substantially parallel to the first direction.

FIGS. 4 and 7 also show an example of how the front crossmember 810 can influence alignment of the headlamp assemblies 6. The front crossmember 810 comprises a first headlamp assembly aligner 816 for aligning the first headlamp assembly 6A and comprises a second headlamp assembly aligner 818 for aligning the second headlamp assembly 6B.

As shown in FIG. 7, a headlamp assembly 6 can extend to the front crossmember 810. The example of FIG. 7 shows a headlamp inner portion 660 in the form of a headlamp inner bracket (inner meaning laterally closer to centreline than 600, 610, 620, 400), close to headlamp-to-grille interface). The headlamp inner portion 660 of the headlamp assembly 6 comprises a headlamp-to-crossmember aligner 662.

The headlamp-to-crossmember aligner 662 of the headlamp assembly 6 is configured to enable the headlamp assembly 6 to be aligned with the headlamp assembly aligner 816 of the front crossmember 810, to enable relative alignment between the headlamp assembly 6 and the front crossmember 810. The headlamp assembly aligner 816 of the front crossmember 810 is configured to guide the headlamp assembly 6 towards an aligned position.

In an example, an alignment boss (e.g., cruciform) is guided by a slotted opening 816 that is slotted in the x-axis direction. In the illustrated example, the headlamp-to-crossmember aligner 662 of the headlamp assembly 6 comprises the alignment boss. The headlamp assembly aligner 816 of the front crossmember 810 comprises the slotted opening. In another example, the headlamp assembly 6 comprises the opening and the front crossmember 810 comprises the alignment boss.

As shown in FIGS. 4-5, the opposite end region of the front crossmember 810 comprises a second headlamp assembly aligner 818, at a set lateral distance (set width, in y-axis) from the first headlamp assembly aligner 816, for aligning the second headlamp assembly 6. The lateral distance is accurate and consistent because the front crossmember 810 can be manufactured more accurately than the relatively inaccurate BIW 100. Therefore, by using the accurately positioned headlamp assembly aligners 816, 818 of the front crossmember 810, the headlamp assemblies 6 can be precisely aligned with each other such that the grille opening has an accurate width.

The front crossmember 810 may be configured to rest loosely on the front crossmember fixing points 800 of the vehicle body 100, while engaged with the headlamp assemblies 6, until the desired alignment of the headlamp assemblies 6 has been achieved. Then the front crossmember 810 can be secured to the front crossmember fixing points 800. In FIGS. 3-4, the front crossmember fixing point 800 may comprise a substantially horizontal platform surface 806 (bearing surface) over which the horizontal leg 820 of the front crossmember 810 can be laid. The horizontal leg 820 of the front crossmember 810 may comprise both the headlamp assembly aligners 816, 818 and the body fixing points.

The front crossmember fixing point 800 of the vehicle body 100 may also be connectable directly to the headlamp assembly 6, and not just indirectly via the front crossmember 810. The connection may be a laterally flexible connection, described below.

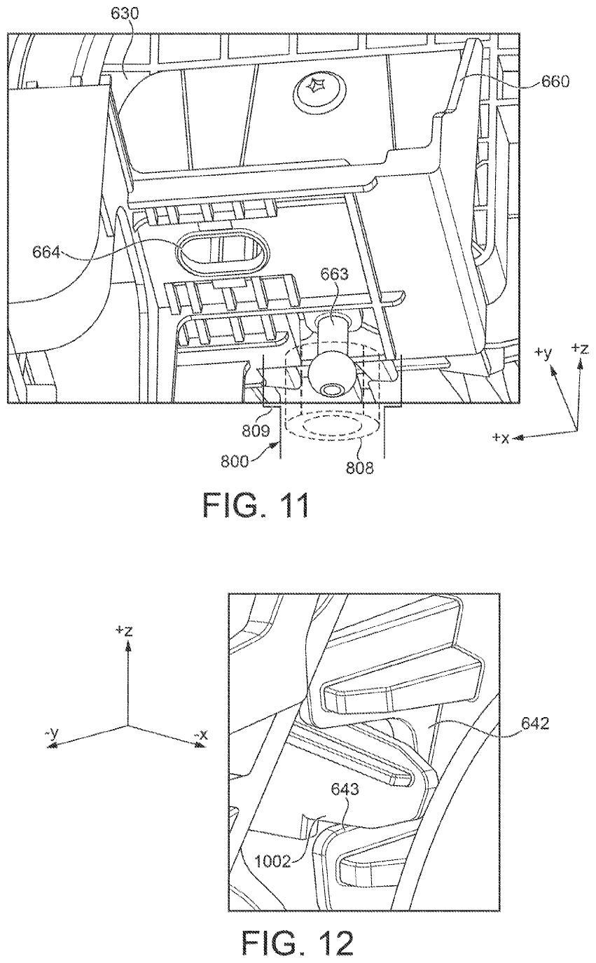

FIG. 3 illustrates the front crossmember fixing point 800 comprising a fixing point 809 for FIG. 11's laterally flexible connector 663, 808. Turning to FIG. 11, the illustrated laterally flexible connector comprises a laterally flexible bias 808 such as a rubber bung, mounted within an opening (the fixing point 809) having an enlarged diameter along at least part of its depth. The laterally flexible bias 808 can resiliently contort in at least the y-axis within the enlarged diameter part of the opening. The laterally flexible connector 663, 808 defines an upright interface such as a plug-and-socket joint (e.g., ball-and-socket joint). The laterally flexible bias 808 may comprise the socket (e.g., hole in the rubber bung) and the headlamp assembly 6 may comprise the plug 663 (e.g., ball stop protrusion), or vice versa.

If the upright interface is misaligned in at least the y-axis, the laterally flexible bias 808 is resiliently contorted in at least the y-axis and imparts a laterally centralising reaction force on the headlamp assemblies 6 that acts to self-centralise the front grille 10 (and by extension the front bumper panel 8) between the headlamp assemblies 6. Meanwhile, the front crossmember 810 ensures a fixed width between the headlamp assemblies 6. Together, the front crossmember 810 and the laterally flexible connector 663, 808 promote a centralised front grille 10, accurate headlamp-to-grille interfaces 644, and accurate headlamp-to-bumper interfaces 646.

FIG. 7 also illustrates the head of a fixing 804, securing the headlamp inner portion 660 of the headlamp assembly 6 to the front crossmember fixing point 800 of the vehicle body 100. The fixing 804 may be tightened once the desired alignment of the headlamp assembly 6 has been achieved.

FIG. 5 illustrates in more detail how the front crossmember 810 can also set a position of the front bumper panel 8, for instance in a vertical direction.

FIG. 5 illustrates the front crossmember 810, an adapter 830 for securing the bumper rail 840A to the front crossmember 810, and the bumper rail 840A for positioning the front bumper panel 8. The bumper rail 840A may also function as a pedestrian rail. The bumper rail 840A comprises bumper positioning points 844 for setting a position of the front bumper panel 8 in the vertical direction and supporting the front bumper panel 8 in the vertical direction. The bumper positioning points may comprise fastening points. The bumper rail 840A further comprises pedestrian rail features. For example, the bumper rail 840A can be comprised of a material, such as a polymeric material, having a lower rigidity than a material of the front crossmember 810. Further, the bumper rail 840A can comprise a longitudinally sloped portion 842, sloped upwards with increasing aftwards distance, to rotate an external body (pedestrian's leg) about the y-axis so that the upper torso of the pedestrian rotates towards the hood panel 2. The front crossmember 810 comprises bumper rail fixing points 824 (e.g., openings for fixings) configured to receive the bumper rail 840A and/or the adapter 830 for the bumper rail 840A.

By aligning the bumper panel 8 to the front crossmember 810 rather than the BIW 100, the bumper panel 8 is aligned relative to the headlamp assemblies 6, rather than the BIW 100. Therefore, the front crossmember 810 optimises both the headlamp-to-grille interface 644 and the headlamp-to-bumper interface 646. The headlamp assemblies 6, the front grille 10, and the top of the bumper panel 8 are all aligned relative to each other.

The bumper rail 840A may further comprise a datum point 846, such as the illustrated tab or any other visual marking, to visually indicate a reference datum of the bumper rail 840A. The reference datum may indicate the lateral centreline (y=0) of the vehicle 1. This assists with ensuring that the bumper panel 8 is at a centred position.

In the illustrated implementation, the adapter 830 has the same type of shape as the front crossmember 810, and has approximately the same length. The adapter 830 may therefore comprise a horizontal leg that extends over the horizontal leg 820 of the front crossmember 810, and a vertical leg located fore of the vertical leg 822 of the front crossmember 810. The horizontal leg of the adapter 830 may comprise openings 812′, 814′, 816′, 818′ aligned with the corresponding openings 812, 814, 816, 818 of the horizontal leg 820 of the front crossmember 810. The vertical leg of the adapter 830 may comprise openings 824′ aligned with the corresponding bumper rail fixing points 824 of the front crossmember 810. The adapter 830 may comprise additional upper bumper rail fixing points 832 securable to corresponding upper fixing points 832′ on the bumper rail 840A.

FIGS. 7-9 further indicate a grille locator 642 for further improving alignment of the front grille 10. Each headlamp assembly 6 may comprise a grille locator 642. Each grille locator 642 is configured to receive a rear-facing grille protrusion 1002 of the front grille 10. The grille locator 642 is configured to guide the front grille 10 to align the headlamp-to-grille interface 644 as the rear-facing grille protrusion 1002 is engaged with the grille locator 642.

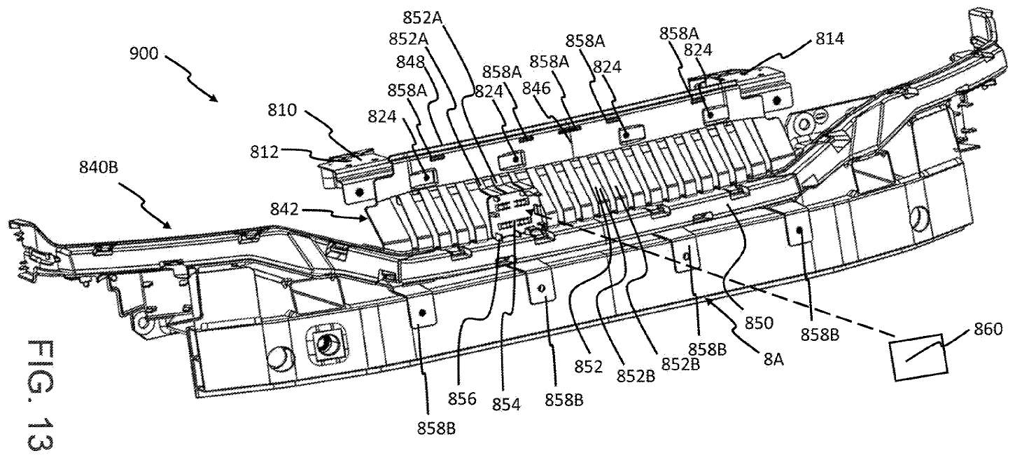

An advantage of providing the grille locator 642 on the headlamp assembly 6 rather than on another part of the vehicle 1 is that the headlamp-to-grille interface 644 is optimised and not affected by misalignment of the BIW 100. The grille locator 642 may vertically guide the front grille 10. The grille locator 642 may comprise a guide platform 643 on which the rear-facing grille protrusion 1002 is supported. The height of the guide platform 643 sets the vertical alignment of the headlamp-to-grille interface 644. The illustrated rear-facing grille protrusion 1002 of the front grille 10 comprises a tapered plug that tapers in height in the +x (aft) direction to a thin tip at the aft-facing end of the tapered plug. The illustrated guide platform 643 comprises a guide edge, which the rear-facing grille protrusion 1002 can rest on as shown in FIG. 12.

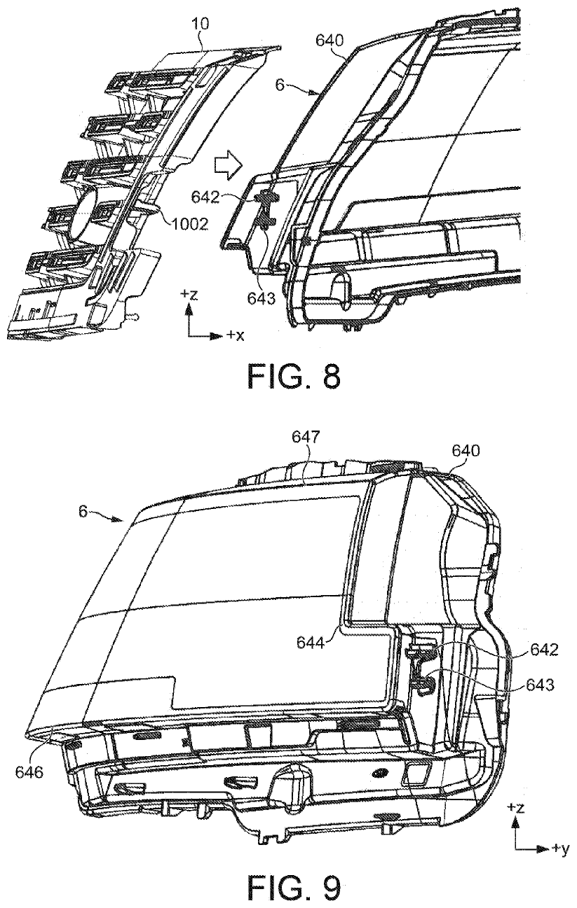

The grille locator 642 may be configured as a locating mouth, vertically oversized relative to the aft tip of the rear-facing grille protrusion 1002, and vertically undersized relative to a fore base of the rear-facing grille protrusion 1002. For example, the grille locator 642 may comprise an upper edge and a lower edge to define the locating mouth, wherein the lower edge is the guide platform 643. The locating mouth design ensures that the rear-facing grille protrusion 1002 cannot be pushed beyond a threshold distance through the grille locator 642. When each rear-facing grille protrusion 1002 is at the threshold distance, the front grille 10 is at the required position in the x-axis. The grille locator 642 may be located at an inboard (inner) lateral side of a headlamp assembly lens body 640 as shown in FIGS. 8-9. The headlamp assembly lens body 640 is a body that is within a front-access cavity 638 of the headlamp assembly housing 630. The headlamp assembly lens body 640 is the body that comprises a headlamp lens through which headlight is projected.

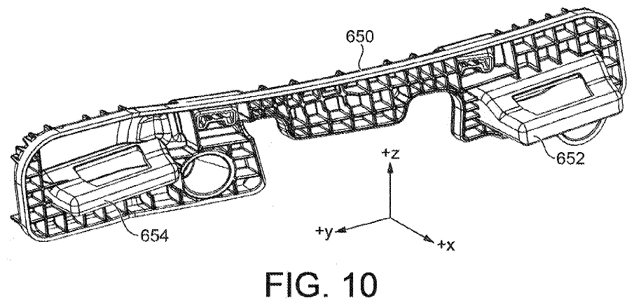

FIG. 10 further illustrates a bumper locator 650 securable to the headlamp assembly 6, or which is an integral part of the headlamp assembly 6. In an implementation, the bumper locator 650 is securable to FIG. 6's bumper locator fixing points 668 of the headlamp assembly housing 630.

A bumper locator 650 may be provided beneath each headlamp assembly 6. The bumper locator 650 may be a moulded part.

The bumper locator 650 comprises fastening points 652, 654 configured to engage with rear-facing bumper portions such as snap fit joints, to secure the front bumper panel 8 at a bumper position that optimises the alignment of the headlamp-to-bumper interface 646, pushing any misalignments to other, less noticeable, areas of the vehicle 1.

FIG. 13 illustrates an alternative bumper rail 840B compared to the bumper rail 840A shown in FIG. 5. The bumper rail 840B is for supporting and positioning a front bumper assembly, the front bumper assembly having a bumper 8 (FIG. 2) and an optional lower bumper beam 8A.

The bumper rail 840B comprises an assembly of parts, formed from a polymeric material(s) or another suitably deformable non-structural material less rigid than the front crossmember 810. The parts include an upper member 848, a lower member 850, and a sloped portion 842 comprising a plurality of crumple members 852 connecting the lower and upper members 848, 850 to each other. The parts may be assembled or integrally-formed.

The upper member 848 is a beam connectable to the front crossmember 810. The upper member 848 extends substantially in the y-axis. The upper member 848 is shaped to fit to the front crossmember 810. The upper member 848 has a span length shorter than or approximately equal to that of the front crossmember 810. The upper member 848 has fixing points (e.g., holes) alignable with the bumper rail fixing points 824 (e.g., holes) of the front crossmember 810, so that the upper member 848 can be attached (e.g., bolted) to the front crossmember 810. The upper member 848 may have a similar cross-section shape and function to the earlier-described adapter 830.

The lower member 850 is a beam (either one-piece or an assembly) that extends across most of the width of the vehicle 1 and is connectable to the vehicle body 100, proximal to wheel arches (not shown) of the vehicle. The lower member 850 therefore has a longer span than the upper member 848 and the front crossmember 810. The lower member 850 may have a convex shape in the x-y plane, in the same direction as a curvature of the front bumper panel 8 which is not shown in FIG. 13. The lower member 850 may have a hollow or profiled cross-section shape. The lower and upper members 848, 850 may each be formed from a polymeric material.

The upper member 848 comprises bumper assembly positioning points 858A in the form of horizontal slots through which tapered rear-facing protrusions (not shown) of the bumper 8 are insertable. The tapered shape (e.g., trapezoidal) of the rear-facing protrusions of the bumper 8 causes a self-alignment of the bumper 8 relative to the upper member 848 in at least a lateral direction. Additionally, or alternatively, bumper assembly positioning points 858A and rear-facing protrusions may be configured to direct the self-alignment in a vertical direction.

The lower member 850 comprises bumper assembly positioning points 858B which may also function as fixing points. In the illustrated example, but not necessarily in all examples, the bumper assembly positioning points 858B are brackets connected to the lower member 850, for receiving fixings to connect a lower bumper beam 8A of the front bumper assembly to the lower member 850. Therefore, in the illustrated example, the lower and upper members 848, 850 each comprise bumper assembly positioning points 858A, 858B. In other implementations, just one of the members may comprise such points.

The sloped portion 842 comprises a series/row of crumple members 852, extending generally parallel to each other, and sloped downwards in a longitudinal fore direction to support the central third or half of the span of the lower member 850. The crumple members 852 can connect a lower portion (e.g., bottom edge) of the upper member 848 to an upper portion (e.g., top surface/edge) of the lower member 850.

The use of crumple members 852 can improve pedestrian impact functionality of the bumper rail 840B in one or more of the following ways. Firstly, a crumple member 852 is a plate or other shape having a lower (substantially lower) rigidity than the lower or upper members, 848, 850. Secondly, a crumple member 852 is formed from a polymeric material or a similarly deformable material. Thirdly, each crumple member 852 is orientated so that bending induced by aftwards displacement of the lower member 850 is about the minor axis of the crumple member 852 rather than the major axis. In other words, the bending is about the lowest second moment of area of the crumple member 852. Fourth, the crumple members 852 are sloped down to promote rotation of the pedestrian's leg so that the upper torso of the pedestrian rotates towards the hood panel 2.

In a frontal impact with any object, the lower member 850 is displaced first because it is the foremost part of the bumper rail 840B. The lower member 850 displaces in an aft direction. This buckles at least some of the crumple members 852, including those closest to the point of impact. The numerous quantity of crumple members 852 ensures that the loads are laterally distributed across the vehicle 1. Twenty-two crumple members 852 are shown. In other examples, there are more than five, or more than ten, or more than fifteen crumple members 852. The loads are then transferred to the upper member 848, then to the front crossmember 810, and then dissipated into the vehicle body 100. If the impact is at a sufficiently low speed, parts further back in the force path may not be deformed.

In FIG. 13, a ranging sensor mount 854, for a ranging sensor 860, is integrally formed with or connected to the sloped portion 854. The ranging sensor 860 can provide an ADAS (advanced driver assistance system) functionality. The ranging sensor 860 comprises one or more of a LIDAR sensor, or a RADAR sensor The illustrated ranging sensor mount 854 is in the form of a mounting plate, shown in an upright orientation (e.g., generally vertical), having one or more forwardly-extending connectors 856 to hold the ranging sensor 860. The mounting plate may be flat. To support the ranging sensor mount 854 in an upright orientation, a lower portion (bottom edge) of the ranging sensor mount 854 is connected to the upper portion (e.g., top surface) of the lower member 850, and an upper portion (top edge) of the ranging sensor mount 854 is connected to a subset 852A of the crumple members 852. The ranging sensor mount 854 is fore of the upper member 848 but aft of the lower member 850 and lower bumper beam 8A.

The subset 852A of crumple members 852 are shorter than the other crumple members 852B and are sloped down from the upper member 848 at a shallower angle than the other crumple members 852B, to connect to the upper portion (top edge) of the ranging sensor mount 854. The remainder of crumple members 852 are regarded as another subset 852B. The subset 852A connected to the ranging sensor mount 854 includes three of the crumple members 852, or can include another number of the crumple members 852 less than half the total number of crumple members 852, such as less than five crumple members 852.

A benefit of mounting the ranging sensor 860 to the bumper rail 840B rather than to the bumper panel 8 is that the position of the ranging sensor mount 854 is less affected by vehicle body misalignments and panel misalignments. This is useful because ranging sensors need to be placed at accurate positions on vehicles. Firstly, the ranging sensor mount 854 is very close to the accurately-aligned front crossmember 810. Secondly, the ranging sensor mount 854 is very close to the datum point 846 (e.g., within 30 cm). Thirdly, the ranging sensor mount 854 is connected to the same component 8402 that has the datum point 846. The ranging sensor mount 854 is close enough to the centre of the bumper rail 840B such that the subset 852A of crumple members 852 that support the ranging sensor mount 854 does not include a laterally outermost one of the crumple members 852.

A further benefit of the mounting location shown is that the ranging sensor 860 is protected at a recessed location behind the front grille 10 or bumper 8. In the event of a low-speed collision, the lower bumper beam 8A deforms first and therefore may not deform the lower member 850 which is aft of the lower bumper beam 8A. Even if the lower member 850 does slightly deform, the numerous quantity of crumple members 852 ensure that the deformation is spread over a wide lateral area. This ensures that the deformation of any one crumple member 852 is not excessive. The majority (more than half, or more than two-thirds, or more than three-quarters) of the crumple members 852A are not connected to the ranging sensor mount 854, and can therefore distribute impact loads to the upper member 848 without displacing the ranging sensor mount 854. Since the ranging sensor 860 is recessed, it would be appreciated that the front grille 10/bumper 8 are configured not to block incident electromagnetic radiation in a field of view of the ranging sensor 860.

Regarding the datum point 846, a visual marking is shown in FIG. 13. Additionally, or alternatively, the upper member 848 can comprise a rear-facing tapering protrusion such as a cruciform (not shown) that can be pushed through a central opening in the front crossmember 810 to centrally align the upper member 848 with the front crossmember 810. This provides further assurance of the correct positioning of the ranging sensor mount 854.

In addition, it would be desirable to prevent other parts of the vehicle, such as headlamp assemblies 6 or other body panels 2, 4, 10, from being misaligned in a manner that pushes the front bumper panel 8 out of alignment, because this could cause some deflection of the bumper rail 840B and therefore some misalignment of the ranging sensor mount 854. Therefore, any or all of the earlier-described alignment features described in this specification synergistically help to ensure that the misalignments of the vehicle body 100 are unlikely to displace the ranging sensor mount 854 from its intended position.

The above-described features (1—common first fixing direction; 2—front crossmember, 3—grille aligner; 4—laterally-flexible connector; 5—bumper locator, 6—datum point) can be provided in isolation, but together provide a synergistic effect of improving the alignment around the headlamp assemblies 6.

It will be appreciated that various changes and modifications can be made to the present invention without departing from the scope of the present application.

Although embodiments of the present invention have been described in the preceding paragraphs with reference to various examples, it should be appreciated that modifications to the examples given can be made without departing from the scope of the invention as claimed. Features described in the preceding description may be used in combinations other than the combinations explicitly described.

Although functions and functions have been described with reference to certain features, those functions and functions may be performable by other features whether described or not.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A system comprising a front crossmember for a vehicle, and a bumper rail for positioning a front bumper assembly of the vehicle,
the front crossmember comprising:
a first body fixing point securable to a vehicle body of the vehicle at a first lateral side of the vehicle body;
a second body fixing point securable to the vehicle body at a second lateral side of the vehicle body; and
bumper rail fixing points configured to receive the bumper rail,
the bumper rail comprising:
bumper assembly positioning points for setting a position of the front bumper assembly in a direction; and
a ranging sensor mount to support a ranging sensor;
wherein the bumper rail spans between the first and second lateral sides of the vehicle body.

2. (canceled)

3. The system of claim 1, wherein the bumper rail comprises a sloped portion to rotate an external impacted body about a lateral axis of rotation towards a hood panel of the vehicle.

4. The system of claim 3, wherein the bumper rail comprises an upper member securable to the front crossmember, and a lower member, wherein the lower member is at a lower elevation than the upper member and is at a fore location relative to the upper member, and wherein the sloped portion interconnects the lower and upper members.

5. The system of claim 4, wherein a longitudinal position of the ranging sensor mount is recessed in a vehicle-aft direction relative to the lower member.

6. The system of claim 4, wherein the bumper assembly positioning points are arranged to hold the front bumper assembly at a longitudinal position fore of the lower member of the bumper rail and the ranging sensor mount.

7. The system of claim 4, wherein a lower portion of the ranging sensor mount is supported by the lower member.

8. The system of claim 4, wherein the sloped portion comprises a plurality of crumple members, and wherein the ranging sensor mount is supported at least in part by a first subset of the crumple members.

9. The system of claim 8, wherein a second subset of the crumple members comprises a plurality of substantially parallel crumple members, and wherein the first subset of crumple members extends at a different angle than the second subset to support an upper portion of the ranging sensor mount to hold the ranging sensor mount in an upright orientation.

10. The system of claim 1, wherein the bumper rail comprises a material having a lower rigidity than a material of the front crossmember.

11. The system of claim 1, wherein the bumper rail comprises a datum point to visually indicate a reference datum of the bumper rail.

12. The system of claim 1, the front crossmember comprising:
a first headlamp assembly aligner configured to guide a first headlamp assembly at the first lateral side of the vehicle body towards an aligned position; and
a second headlamp assembly aligner, at a set lateral distance from the first headlamp assembly aligner, configured to guide a second headlamp assembly at the second lateral side of the vehicle body towards an aligned position.

13. The system of claim 1, wherein the direction in which the bumper assembly positioning points are configured to set a position of the front bumper assembly is a lateral direction.

14. A vehicle comprising the system of claim 1, and a vehicle body.

15. The vehicle of claim 14, wherein the vehicle body comprises front crossmember fixing points configured to receive fixings from a first direction when the front crossmember is secured to at least the front crossmember fixing point, and wherein the vehicle body comprises further fixing points configured to receive fixings from a direction substantially parallel to the first direction when one or more vehicle body panels and/or headlamp assemblies configured to interface with the front bumper assembly are secured to the further fixing points.

16. The vehicle of claim 15, wherein a portion of a laterally flexible connector is mounted to each front crossmember fixing point, and wherein each laterally flexible connector is configured to connect a respective headlamp assembly to the vehicle body.
